(19) United States
(12) Patent Application Publication
(10) Pub. No.: US 2026/0188780 A1
(43) Pub. Date: Jul. 2, 2026

(54) METHOD FOR MANUFACTURING BATTERY MODULE

(71) Applicant: SUBARU CORPORATION, Tokyo (JP)

(72) Inventor: Hiroto SETO, Tokyo (JP)

(21) Appl. No.: 19/412,024

(22) Filed: Dec. 8, 2025

(30) Foreign Application Priority Data
Dec. 27, 2024 (JP) 2024-232097

(51) Int. Cl. H01M 10/6555; H01M 10/643; H01M 50/213

(52) U.S. Cl. CPC H01M 10/6555; H01M 10/643; H01M 50/213

(57) ABSTRACT

A method of manufacturing a battery module is provided. The battery module includes a stacked body including stacked units each including a first cell group and a second cell group in which cells extending in a first direction are arranged in a second direction orthogonal to the first direction, and a temperature control plate disposed between the first cell group and the second cell group and extending in the second direction. The method includes: capturing the stacked body; determining a first reference position of the stacked body based on a captured image; acquiring first position information representing a relative position of each part of the stacked body with respect to the first reference position based on the image; storing the first reference position and the first position information; and sharing the stored first reference position and first position information in subsequent steps.

### CROSS-REFERENCE TO RELATED APPLICATIONS

The present application claims priority from Japanese Patent Application No. 2024-232097 filed on Dec. 27, 2024, the entire contents of which are hereby incorporated by reference.

### BACKGROUND

The present disclosure relates to a method for manufacturing a battery module.

Conventionally, there has been known an electric vehicle that can travel by a motor using electric power stored in a battery module in a battery pack. For example, Japanese Unexamined Patent Application Publication (Translation of PCT Application) (JP-T) 2023-502274 discloses a battery pack that is disposed at the center of a lower portion of a vehicle body of an electric vehicle and includes battery modules. The battery module of JP-T No. 2023-502274 includes a stacked body in which units including a first cell group, a second cell group, and a temperature control plate disposed between the first cell group and the second cell group are stacked.

### SUMMARY

An aspect of the disclosure provides a method of manufacturing a battery module. The battery module includes a stacked body. The stacked body includes stacked units. The stacked units each include a first cell group and a second cell group, and a temperature control plate. In the first cell group and the second cell group, cells extending in a first direction are arranged in a second direction orthogonal to the first direction. The temperature control plate is disposed between the first cell group and the second cell group and extends in the second direction. The method includes capturing the stacked body, determining a first reference position, acquiring first position information, storing the first reference position and the first position information, and sharing the stored first reference position and first position information. The stacked body is captured. The first reference position of the stacked body is determined based on a captured image. The first position information representing a relative position of each part of the stacked body with respect to the first reference position is acquired based on the image. The first reference position and the first position information are stored. The stored first reference position and first position information are shared in subsequent steps.

### BRIEF DESCRIPTION OF THE DRAWINGS

FIG. 1 is a cross-sectional view illustrating an example of a configuration of a battery module according to the present embodiment;

FIG. 2 is a schematic view illustrating a configuration of a stacked body;

FIG. 3 is a flowchart for describing a method for manufacturing the battery module according to the present embodiment;

FIG. 4 is a flowchart for describing a detailed flow from a positioning step to a wire bonding step;

FIG. 5 is a schematic view illustrating an example of the positioning step;

FIG. 6 is a schematic view illustrating an example of a laser cleaning step;

FIG. 7 is a schematic view illustrating an example of the wire bonding step; and

FIG. 8 is a flowchart for describing a detailed flow from a positioning step to a wire bonding step in the method for manufacturing the battery module 1 according to the modification.

### DETAILED DESCRIPTION

In a case where at least a part of a manufacturing process of a battery module is automated, it is necessary for the manufacturing apparatus to recognize the position of each part of a stacked body. For example, if the recognition of the position of each part of the stacked body is performed for each manufacturing process, the processing of recognizing the position of each part of the stacked body takes time, and the productivity of the battery module may be reduced.

It is desirable to provide a method for manufacturing a battery module capable of improving productivity.

Hereinafter, an embodiment of the disclosure will be described in detail with reference to the accompanying drawings. Specific dimensions, materials, numerical values, and the like illustrated in such an embodiment are merely examples for facilitating understanding of the disclosure, and do not limit the disclosure unless otherwise specified. Note that, in the present specification and the drawings, elements having substantially the same function and configuration are denoted by the same reference numerals, and redundant description is omitted, and elements not directly related to the disclosure are not illustrated.

### Battery Module

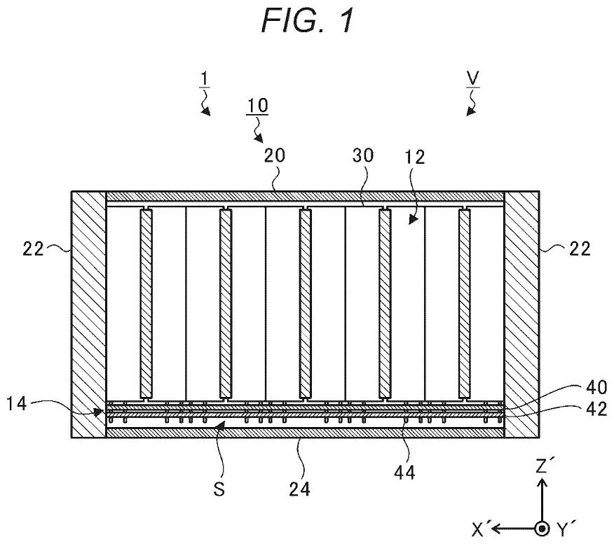

FIG. 1 is a cross-sectional view illustrating an example of a configuration of a battery module 1 according to the present embodiment. In FIG. 1, an X′ direction indicates a width direction of the battery module 1, a Y′ direction indicates a length direction of the battery module 1, and a Z′ direction indicates a height direction of the battery module 1.

The battery module 1 may be mounted on a vehicle V such as an electric vehicle including a motor generator as a drive source. Note that the vehicle V is not limited to an electric vehicle, and may be a hybrid electric vehicle including a motor generator and an engine as a drive source. In addition, the battery module 1 is not limited to be mounted on the vehicle V, and may be mounted on various apparatuses.

The battery module 1 includes a case 10, a stacked body 12, and a bus bar module 14.

The case 10 forms a housing space S therein. The case 10 includes an upper cover 20, a side plate 22, and a lower cover 24. A space surrounded by the upper cover 20, the side plate 22, and the lower cover 24 is a housing space S. The stacked body 12 and the bus bar module 14 are accommodated in the housing space S inside the case 10. The stacked body 12 is positioned on an upper side in the Z′ direction with respect to the bus bar module 14.

The upper cover 20 is disposed on an upper side in the Z′ direction with respect to the stacked body 12. The upper cover 20 has a rectangular flat plate shape. The upper cover 20 covers the upper side of the stacked body 12 in the Z′ direction.

The lower cover 24 is disposed below the bus bar module 14 in the Z′ direction. The lower cover 24 has a rectangular flat plate shape. The lower cover 24 covers the lower side of the bus bar module 14 in the Z′ direction.

A pair of side plates 22 is disposed on both sides in the X′ direction with respect to the stacked body 12 and the bus bar module 14. The side plate 22 has a rectangular flat plate shape. The side plate 22 covers both sides of the stacked body 12 and the bus bar module 14 in the X′ direction. The upper cover 20 is coupled to an upper end of the side plate 22 in the Z′ direction. The lower cover 24 is coupled to a lower end of the side plate 22 in the Z′ direction.

The stacked body 12 includes cells 30. The cells 30 are single batteries of chargeable/dischargeable secondary batteries such as lithium ion batteries. The cells 30 are each assumed to be formed in a columnar shape, but are not limited to a columnar shape, and may be formed in various shapes such as a prismatic shape and an elliptical columnar shape. Each of the cells is disposed upright so as to extend in the height direction (Z′ direction in FIG. 1) of the battery module 1. The cell 30 has positive and negative electrodes. The stacked body 12 will be described in detail later.

The bus bar module 14 includes a bus bar plate 40, bus bars 42, and wires 44. The bus bar plate 40 holds the bus bars 42. The bus bar 42 is formed of a conductive material in a sheet shape or a plate shape. Each of the wires 44 electrically couples one of the electrodes of one of the cells 30 and one of the bus bars 42. The bus bar 42 electrically couples the electrodes of the cells 30 via the wire 44. The cells 30 are coupled in parallel and in series via the wires 44 and the bus bars 42.

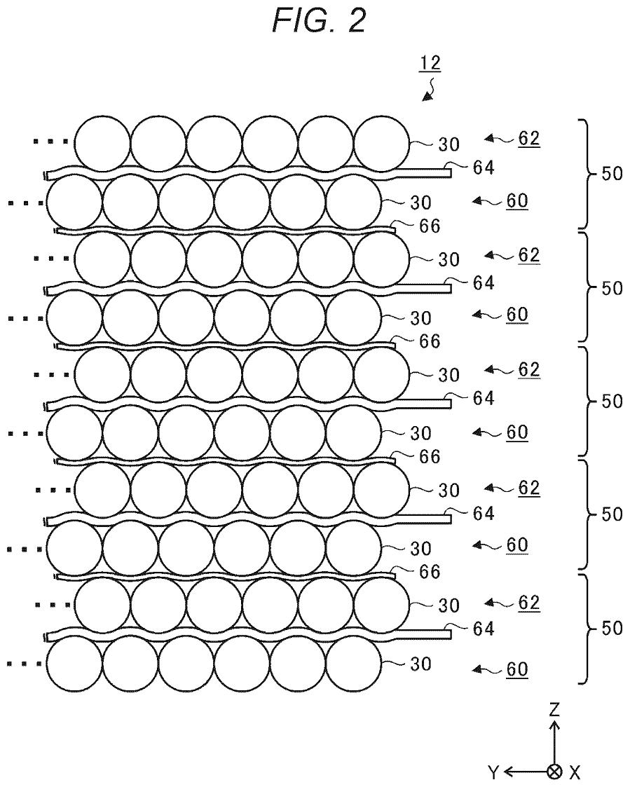

FIG. 2 is a schematic view illustrating a configuration of the stacked body 12. FIG. 2 illustrates a state in which the stacked body 12 illustrated in FIG. 1 is viewed from the Z′ direction in FIG. 1. In FIG. 2, an X direction is a first direction corresponding to an extending direction of the cell 30. In FIG. 2, a Y direction is a second direction orthogonal to the X direction, and corresponds to a direction in which the cells 30 are arranged. In FIG. 2, a Z direction is a third direction orthogonal to the X direction and the Y direction, and corresponds to a stacking direction of units 50 described later. The X direction in FIG. 2 corresponds to the Z′ direction in FIG. 1, the Y direction in FIG. 2 corresponds to the Y′ direction in FIG. 1, and the Z direction in FIG. 2 corresponds to the X′ direction in FIG. 1.

The stacked body 12 includes units 50. Each of the units 50 includes a first cell group 60, a second cell group 62, a temperature control plate 64, and an insulating sheet 66. The unit 50 may include two types including one including the insulating sheet 66 and one not including the insulating sheet 66. Hereinafter, for convenience of description, the first cell group 60 and the second cell group 62 may be collectively referred to simply as a cell group without distinction.

Each of the first cell group 60 and the second cell group 62 includes cells 30. Each of the cells 30 is disposed to extend in the first direction (X direction in FIG. 2). That is, the central axis of the cell 30 extends in the X direction.

The first cell group 60 is configured so that cells 30 extending in a first direction are arranged in a second direction (Y direction in FIG. 2) orthogonal to the first direction. In the example of FIG. 2, six cells 30 arranged in the Y direction are illustrated as the first cell group 60. However, the number of cells 30 constituting the first cell group 60 may be plural, and may be equal to or less than 5 or equal to or more than 7.

The second cell group 62 is a cell group configured separately from the first cell group 60, and is configured so that cells 30 extending in the first direction are arranged in a second direction (Y direction in FIG. 2) orthogonal to the first direction. The direction in which the cells 30 constituting the second cell group 62 are arranged is the same as the direction in which the cells 30 constituting the first cell group 60 are arranged. Hereinafter, for convenience of description, the direction in which the cells 30 constituting the cell group are arranged may be referred to as a parallel direction.

In the example of FIG. 2, six cells 30 arranged in the Y direction are illustrated as the second cell group 62. However, the number of cells 30 constituting the second cell group 62 may be plural, and may be equal to or less than 5 or equal to or more than 7. The number of cells 30 constituting the second cell group 62 is assumed to be the same as the number of cells 30 constituting the first cell group 60, but may be different from the number of cells 30 constituting the first cell group 60.

The temperature control plate 64 is disposed between the first cell group 60 and the second cell group 62. The temperature control plate 64 is formed in a wave plate shape. The temperature control plate 64 is disposed so that a longitudinal direction corresponding to a traveling direction of the wave in the temperature control plate 64 is the same direction as the parallel direction of the cells 30 of the cell group.

The first cell group 60 is coupled to a first surface of two surfaces of the temperature control plate 64 via an adhesive. Each of the cells 30 of the first cell group 60 is accommodated in a valley portion formed on the first surface of the temperature control plate 64. The second cell group 62 is coupled to a second surface of the two surfaces of the temperature control plate 64 via an adhesive. Each of the cells 30 of the second cell group 62 is accommodated in a valley portion formed on the second surface of the temperature control plate 64.

Although not illustrated, a flow path through which a heat medium can flow is formed inside the temperature control plate 64. The temperature control plate 64 performs heat exchange between the heat medium flowing through the internal flow path and the first cell group 60 and the second cell group 62. By this heat exchange, the temperatures of the first cell group 60 and the second cell group 62 are adjusted.

The unit 50 is formed by bonding at least the first cell group 60 to the first surface of the temperature control plate 64 and bonding the second cell group 62 to the second surface of the temperature control plate 64.

The units 50 are stacked in the third direction (Z direction in FIG. 2) orthogonal to the extending direction (first direction) of the cells 30 and the parallel direction (second direction) of the cells 30. That is, the third direction is a stacking direction in which the units 50 are stacked. When the units 50 are stacked, the first cell group 60 and the second cell group 62 are alternately arranged along the stacking direction.

The stacked body 12 is formed by stacking the units 50 with the insulating sheet 66 interposed therebetween. The insulating sheet 66 is formed in a sheet shape by an insulator. The insulating sheet 66 is positioned between the first cell group 60 of one unit 50 of the two adjacent units 50 and the second cell group 62 of the other unit 50. The insulating sheet 66 prevents cell groups adjacent in the stacking direction from coming into contact with each other.

The insulating sheet 66 is bonded to at least one of two cell groups sandwiching the insulating sheet 66 via an adhesive. The insulating sheet 66 may be bonded to a portion of at least one of the first cell group 60 or the second cell group 62 of the unit 50 opposite to the temperature control plate 64.

### Method for Manufacturing Battery Module

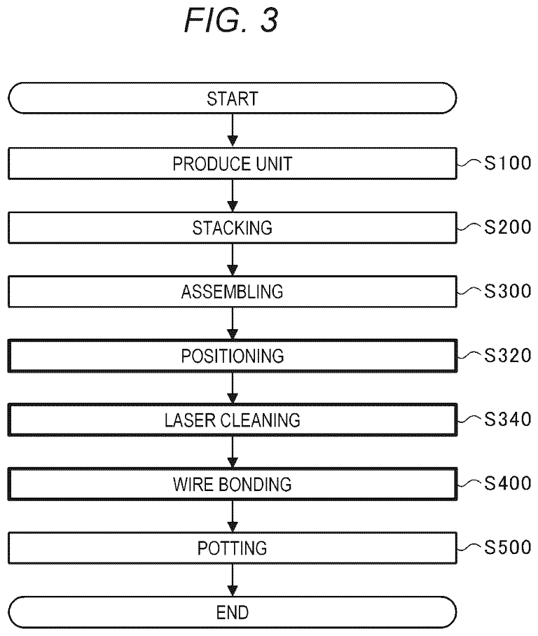

FIG. 3 is a flowchart illustrating a method for manufacturing the battery module 1 according to the present embodiment. As illustrated in FIG. 3, the method for manufacturing the battery module 1 includes a unit producing step S100, a stacking step S200, an assembling step S300, a positioning step S320, a laser cleaning step S340, a wire bonding step S400, and a potting step S500. Each step of the method for manufacturing the battery module 1 may be performed by a manufacturing machine, may be performed by a person, or may be performed by cooperation of the manufacturing machine and the person.

In the unit producing step S100, a unit 50 including the first cell group 60, the second cell group 62, and the temperature control plate 64 is produced. For example, in the unit producing step S100, the first cell group 60 is bonded to the first surface of the temperature control plate 64 via an adhesive, and the second cell group 62 is bonded to the second surface of the temperature control plate 64 via an adhesive. In addition, in the unit producing step S100, for example, the insulating sheet 66 may be bonded to a portion of the second cell group 62 on a side opposite to the temperature control plate 64 via an adhesive.

In the stacking step S200, the units 50 thus produced are stacked with the insulating sheet 66 interposed therebetween to form the stacked body 12 (see FIG. 2).

In the assembling step S300, the bus bar module 14 and the produced stacked body 12 are assembled to at least some members constituting the case 10. For example, in the assembling step S300, the upper cover 20, the side plate 22, the bus bar module 14, and the lower cover 24 are assembled to the stacked body 12. Note that the lower cover 24 is not limited to the example of being assembled in the assembling step S300, and may be assembled after the wire bonding step S400 or may be assembled after the potting step S500.

In the positioning step S320, the position of each part of the stacked body 12 is stored in order to perform the laser cleaning step S340 and the wire bonding step S400 after the positioning step S320. The positioning step S320 will be described in detail later.

In the laser cleaning step S340, laser cleaning is performed on at least the electrodes of the cells 30. For example, in the laser cleaning step S340, the electrodes of the cells 30 are irradiated with a laser, and deposits are evaporated by the energy of the laser, or the deposits are separated by impact at the time of laser irradiation, whereby the deposits are removed from the surfaces of the electrodes. In addition, in the laser cleaning step S340, laser cleaning may be performed on the position where the wire 44 is to be coupled to the bus bar 42.

In the wire bonding step S400, the electrodes of the cells 30 and the bus bars 42 are coupled by the wires 44. Since the laser cleaning step S340 is performed before the wire bonding step S400, a coupling error between the electrode and the wire 44 can be reduced in the wire bonding step S400.

In the potting step S500, potting of filling the inside of the case 10 in which the stacked body 12 and the bus bar module 14 are accommodated with a filler is performed. The potting step S500 is performed in a posture in which the upper cover 20 is positioned below the stacked body 12 and the bus bar module 14 is positioned above the stacked body 12, that is, a posture in which the upper and lower sides of FIG. 1 are reversed. In the potting step S500, a fluid filler is injected into the case 10 from the bus bar module 14 side so that the gap of the stacked body 12 is filled with the filler.

In the potting step S500, the filler is cured when a predetermined time elapses under a predetermined condition after the filler is injected. The predetermined conditions and the predetermined time vary depending on the type and characteristics of the filler. By curing the filler injected into the case 10, the performance of fixing the position of the stacked body 12 inside the case 10 is improved, and structural characteristics, electrical characteristics, and environmental characteristics of the battery module 1 can be improved.

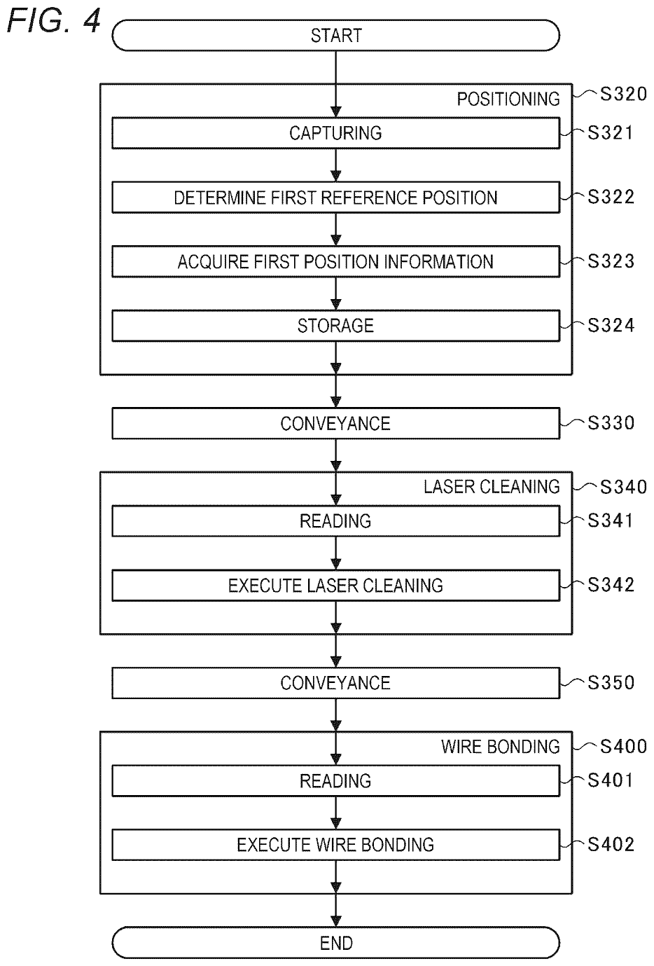

FIG. 4 is a flowchart for describing a detailed flow from the positioning step S320 to the wire bonding step S400.

In the positioning step S320, first, the stacked body 12 of semi-finished products after the assembling step S300 is captured by the imaging device (S321). For example, the stacked body 12 is disposed in a posture in which the electrodes of the cells 30 face upward. The imaging device images the stacked body 12 so that the captured image includes the electrodes and the bus bars 42 of the cells 30. For example, the imaging device performs capturing so that the electrodes of all the cells 30 and all the bus bars 42 of the stacked body 12 are included in one image.

Note that the imaging device may perform capturing so that the electrodes of some of the cells 30 and some of the bus bars 42 of the stacked body 12 are included in one image. In this case, substantially all the cells 30 and all the bus bars 42 of the stacked body 12 may be captured by shifting the capturing range to capture images.

Next, a first reference position of the stacked body 12 is determined based on the captured image (S322). The first reference position includes a characteristic portion serving as a reference for determining a relative position of each part of the stacked body 12. For example, a portion having a predetermined shape in the predetermined bus bar 42 in the image may be set as the first reference position. In addition, when a positioning pin is formed at a predetermined position of the bus bar module 14, a positioning pin in the image may be set as the first reference position.

Next, based on the captured image, first position information representing the relative position of each part of the stacked body 12 with respect to the first reference position is acquired (S323). The first position information may include information on the positions of the positive electrode and the negative electrode for each cell 30, or may include information on the position where the wire 44 is coupled to the bus bar 42.

Next, the captured image, the first reference position, and the first position information are stored in the storage (S324).

The semi-finished product after the positioning step S320, that is, the semi-finished product after the first position information and the like are stored is conveyed to the work place of the laser cleaning step S340 (S330). Note that, when the laser cleaning step S340 is performed in the same work place as the positioning step S320, the conveyance of the semi-finished product may be omitted.

In the laser cleaning step S340, first, the first reference position and the first position information stored in the positioning step S320 are read (S341).

Next, laser cleaning is executed according to the read first reference position and first position information (S342). For example, a characteristic portion substantially the same as the first reference position on the image captured in the laser cleaning step S340 may be set as the origin of the coordinate system of the laser cleaning. In the laser cleaning, the irradiation position of the laser may be determined according to the first position information.

The semi-finished product after the laser cleaning step S340, that is, the semi-finished product for which the laser cleaning is completed is conveyed to the work place of the wire bonding step S400 (S350). Note that, when the wire bonding step S400 is performed in the same work place as the laser cleaning step S340, the conveyance of the semi-finished product may be omitted.

In the wire bonding step S400, first, the first reference position and the first position information stored in the positioning step S320 are read (S401).

Next, wire bonding is performed in accordance with the read first reference position and first position information (S402). For example, a characteristic portion substantially the same as the first reference position on the image captured in the wire bonding step S400 may be the origin of the coordinate system of the wire bonding. In wire bonding, a coupling position of the wire 44 may be determined according to the first position information.

As described above, in the method for manufacturing the battery module 1 of the present embodiment, the first reference position and the first position information stored in the positioning step S320 are shared in the laser cleaning step S340 and the wire bonding step S400 after the positioning step S320. Therefore, in the method for manufacturing the battery module 1 of the present embodiment, the time for the positioning process of each part of the stacked body 12 can be shortened as compared with the aspect in which each part of the stacked body 12 is positioned every time the laser cleaning step S340 and the wire bonding step S400 are performed. As a result, in the method for manufacturing the battery module 1 of the present embodiment, the productivity of the battery module 1 can be improved.

Note that, here, the first reference position and the first position information stored in the positioning step S320 are shared in the laser cleaning step S340 and the wire bonding step S400. However, the process of using the first reference position and the first position information is not limited to the laser cleaning step S340 and the wire bonding step S400. The first reference position and the first position information may be shared in various subsequent steps after the positioning step S320.

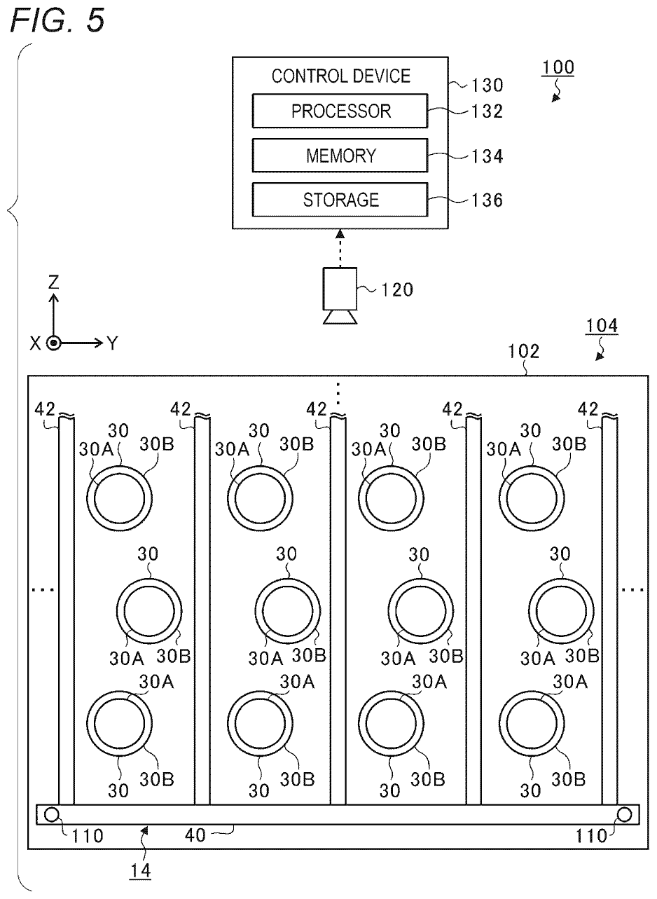

FIG. 5 is a schematic view illustrating an example of the positioning step S320. FIG. 5 illustrates an example of a positioning device 100 that implements the positioning step S320. For convenience of description, the semi-finished product being manufactured as a target of the positioning step S320 may be referred to as a target semi-finished product 102.

A first electrode 30A and a second electrode 30B are provided as electrodes on a first end surface of the cell 30 in the first direction (X direction in FIG. 5). The target semi-finished product 102 is disposed in the work place 104 in the positioning step S320 in a posture in which the electrodes and the bus bars 42 of the cells 30 face vertically upward.

The first electrode 30A and the second electrode 30B are formed of a conductive member. The first electrode 30A is, for example, a positive electrode, and the second electrode 30B is, for example, a negative electrode. Note that, depending on the type of the cell 30, the first electrode 30A may be a negative electrode, and the second electrode 30B may be a positive electrode. The first electrode 30A is formed in a circular shape. The second electrode 30B is formed in an annular shape concentric with the first electrode 30A, and is disposed on an outer periphery of the first electrode 30A.

For example, the bus bar 42 may be disposed so as to extend in the third direction (Z direction in FIG. 5). The bus bar 42 is supported by the bus bar plate 40. For example, the bus bar plate 40 may be disposed so as to extend in the second direction (Y direction in FIG. 5).

The bus bar module 14 may be provided with one or more positioning pins 110. The positioning pin 110 is formed in, for example, a columnar shape, and may protrude or be recessed in the first direction (X direction in FIG. 5) from the surface of the bus bar plate 40.

As illustrated in FIG. 5, the positioning device 100 includes the imaging device 120 and the control device 130. Note that the positioning device 100 may include a stage on which the target semi-finished product 102 is mounted and which is movable.

The imaging device 120 can image the electrode side of the target semi-finished product 102. The imaging device 120 may be movable in the horizontal direction. Note that, when the imaging device 120 is movable or when the positioning device 100 includes a stage, the imaging device 120 may be capable of capturing at least a portion of the target semi-finished product 102.

The control device 130 includes one or more processors 132, one or more memories 134 coupled to the processor 132, and a storage 136. The memory 134 includes a ROM in which a program and the like are stored and a RAM as a work area. The storage 136 includes a nonvolatile storage element. The processor 132 executes various types of processing in cooperation with the program included in the memory 134.

The control device 130 can acquire an image captured by the imaging device 120. For convenience of description, the image captured by the imaging device 120 in the positioning step S320 may be referred to as a first image. The control device 130 may store the acquired first image in the storage 136.

The processor 132 executes the program, so that the control device 130 can analyze the captured first image.

For example, the control device 130 may determine the position of any one positioning pin 110 on the first image as the first reference position. The control device 130 stores the first reference position in the storage 136.

Note that, when the positioning pin 110 is not provided, for example, the control device 130 may determine any position on the bus bar module 14 such as one end portion of the bus bar plate 40 as the first reference position.

In addition, for example, the control device 130 may select one cell 30 among the cells 30 on the first image. The control device 130 may derive the relative position of the first electrode 30A of the selected cell 30 with respect to the first reference position as one piece of the first position information. Similarly, the control device 130 may derive the relative position of the second electrode 30B of the selected cell 30 with respect to the first reference position as one piece of the first position information. The control device 130 may derive the relative position of the first electrode 30A and the relative position of the second electrode 30B for all the cells 30 on the first image.

In addition, for example, the control device 130 may determine the position where the wire 44 is to be coupled to the bus bar 42 from the positional relationship between the cell 30 and the bus bar 42 on the first image. As one piece of the first position information, the control device 130 may derive a relative position of the position where the wire 44 is to be coupled to the bus bar 42 with respect to the first reference position. The control device 130 stores the first position information in the storage 136.

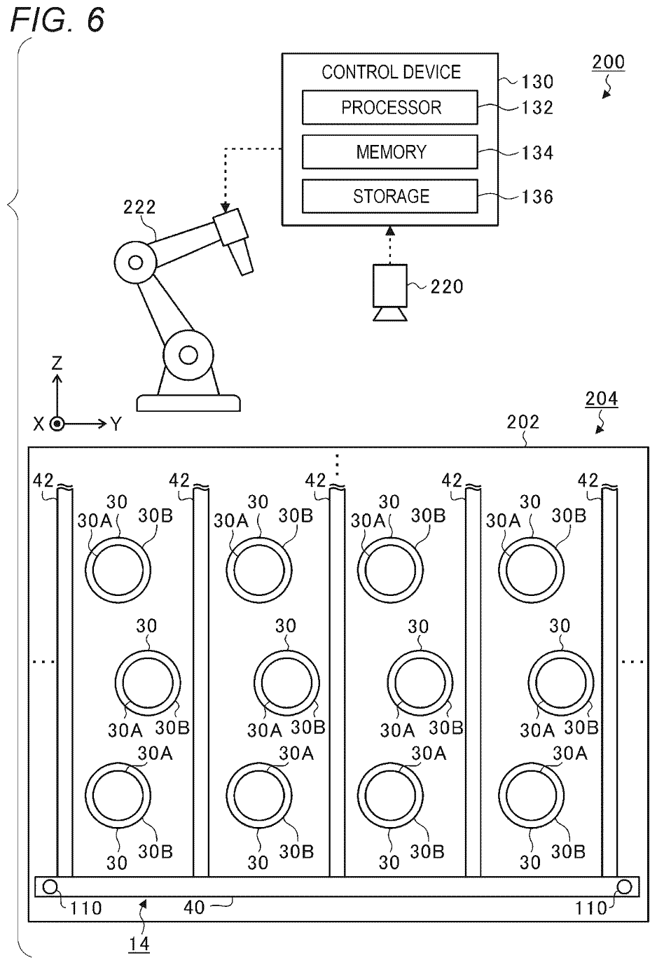

FIG. 6 is a schematic view illustrating an example of the laser cleaning step S340. FIG. 6 illustrates an example of a laser cleaning apparatus 200 that implements the laser cleaning step S340. For convenience of description, the semi-finished product being manufactured as a target of the laser cleaning step S340 may be referred to as a target semi-finished product 202. The target semi-finished product 202 of the laser cleaning step S340 is substantially the same as the target semi-finished product 102 of the positioning step S320. The target semi-finished product 202 is disposed in the work place 204 in the laser cleaning step S340 in a posture in which the electrodes and the bus bars 42 of the cells 30 face vertically upward.

As illustrated in FIG. 6, the laser cleaning apparatus 200 includes a control device 130, an imaging device 220, and a laser irradiation device 222. Note that the laser cleaning apparatus 200 may include a stage on which the target semi-finished product 202 is mounted and which is movable.

The control device 130 of the laser cleaning apparatus 200 is assumed to be the same as the control device 130 of the positioning device 100, but may be different. Note that, when the control device 130 of the laser cleaning apparatus 200 is different from the control device 130 of the positioning device 100, the control device 130 of the laser cleaning apparatus 200 may be able to transmit and receive various types of information to and from the control device 130 of the positioning device 100.

The imaging device 220 can image the electrode side of the target semi-finished product 202. The imaging device 220 may be movable in the horizontal direction. Note that, when the imaging device 220 is movable or when the laser cleaning apparatus 200 includes a stage, the imaging device 220 may be able to image at least a part of the target semi-finished product 202.

The laser irradiation device 222 can irradiate a predetermined position of the target semi-finished product 202 disposed in the work place 204 in the laser cleaning step S340 with a laser. For example, the laser irradiation device 222 may include a torch capable of emitting a laser and an arm capable of moving the torch to any position of the work place 204.

The control device 130 can acquire an image captured by the imaging device 220. For convenience of description, the image captured by the imaging device 220 in the laser cleaning step S340 may be referred to as a second image. The control device 130 may store the acquired second image in the storage 136.

The control device 130 can read the first image, the first reference position, and the first position information stored in the storage 136 in the positioning step S320 in the laser cleaning step S340.

The processor 132 executes the program, so that the control device 130 can analyze the captured second image.

For example, the control device 130 finds, from the second image, the same characteristic portion as the characteristic portion (for example, positioning pin 110) on the first image determined as the first reference position in the positioning step S320. The control device 130 corrects the coordinates of the found characteristic portion (for example, the positioning pin 110 in the second image) in the second image to the origin.

The control device 130 derives a position in the second image represented by the first position information from the origin (for example, coordinates of the positioning pin 110 in the second image) in the second image as the laser irradiation position.

The control device 130 moves the torch to the derived irradiation position, and irradiates the irradiation position with the laser by the laser irradiation device 222.

As described above, the first position information includes the positions of the cells 30 and the position where the wire 44 is coupled to the bus bar 42. Therefore, the control device 130 derives the irradiation position and irradiates the laser with respect to each of the cells 30 and the bus bar 42 represented by the first position information.

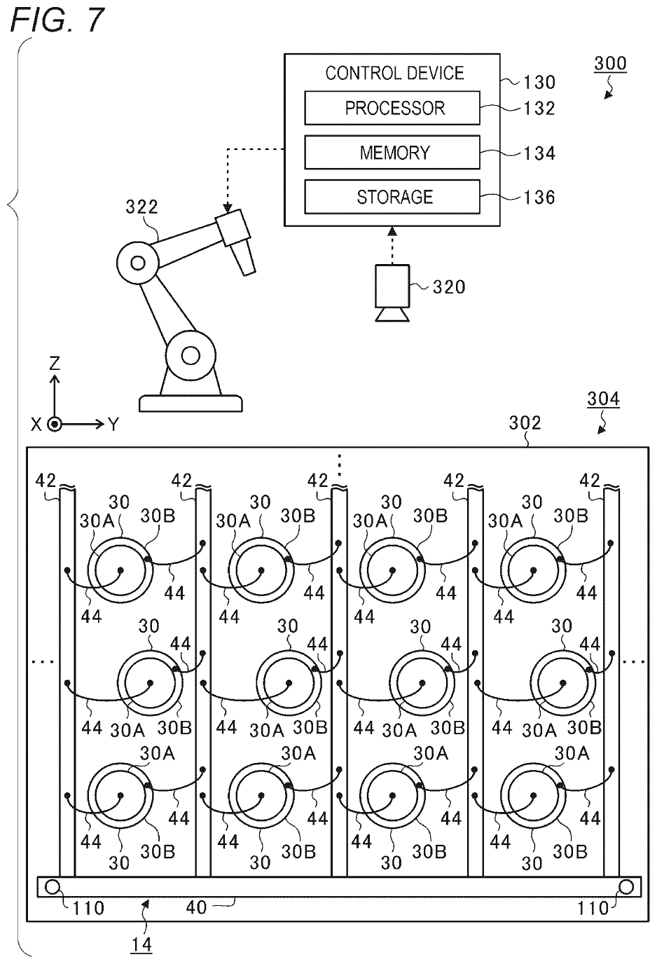

FIG. 7 is a schematic view illustrating an example of wire bonding step S400. FIG. 7 illustrates an example of the bonding system 300 that implements the wire bonding step S400. For convenience of description, the semi-finished product being manufactured as a target of the wire bonding step S400 may be referred to as a target semi-finished product 302. The target semi-finished product 302 is disposed in the work place 304 in the wire bonding step S400 in a posture in which the electrode of the cell 30 and the bus bar 42 face vertically upward. FIG. 7 illustrates a state in which the wire 44 is coupled.

As illustrated in FIG. 7, the bonding system 300 includes a control device 130, an imaging device 320, and a bonding apparatus 322. Note that the bonding system 300 may include a stage on which the target semi-finished product 202 is mounted and which is movable.

The control device 130 of the bonding system 300 is assumed to be the same as the control device 130 of the positioning device 100, but may be different. Note that, when the control device 130 of the bonding system 300 is different from the control device 130 of the positioning device 100, the control device 130 of the bonding system 300 may be able to transmit and receive various types of information to and from the control device 130 of the positioning device 100.

The imaging device 320 can capture the electrode side of the target semi-finished product 302. The imaging device 320 may be movable in the horizontal direction. Note that, when the imaging device 320 is movable or when the bonding system 300 includes a stage, the imaging device 320 may be capable of capturing at least a portion of the target semi-finished product 302.

The bonding apparatus 322 can perform wire bonding by ultrasonic bonding or the like, for example, to a predetermined position of the target semi-finished product 302 disposed in the work place 304 in the wire bonding step S400. For example, the bonding apparatus 322 may include a torch that unwinds the wire 44 and couples the wire 44 to the coupling target, and an arm capable of moving the torch to any position of the work place 304.

The control device 130 can acquire an image captured by the imaging device 320. For convenience of description, the image captured by the imaging device 320 in the wire bonding step S400 may be referred to as a third image. The control device 130 may store the acquired third image in the storage 136.

The control device 130 can read the first image, the first reference position, and the first position information stored in the storage 136 in the positioning step S320 in the wire bonding step S400.

The control device 130 can analyze the captured third image by the processor 132 executing a program.

For example, the control device 130 finds, from the third image, the same characteristic portion as the characteristic portion (for example, positioning pin 110) on the first image determined as the first reference position in the positioning step S320. The control device 130 corrects the coordinates of the found characteristic portion (for example, the positioning pin 110 in the third image) in the third image to the origin.

The control device 130 derives the position in the third image represented by the first position information from the origin (for example, coordinates of the positioning pin 110 in the third image) in the third image as the coupling position of the wire 44.

The control device 130 moves the torch to the derived coupling position, and couples the wire 44 to the coupling position by the bonding apparatus 322.

As described above, the first position information includes the positions of the cells 30 and the position where the wire 44 is coupled to the bus bar 42. Therefore, the control device 130 derives the coupling position of the wire 44 and couples the wire 44 for each of the cells 30 and the bus bar 42 represented by the first position information.

As described above, the battery module 1 of the present embodiment includes: the stacked body 12 including the stacked units 50 each including the first cell group 60 and the second cell group 62 in which the cells 30 extending in the first direction are arranged in the second direction orthogonal to the first direction, and the temperature control plate 64 disposed between the first cell group 60 and the second cell group 62 and extending in the second direction. The method for manufacturing the battery module 1 of the present embodiment includes capturing the stacked body 12. The method for manufacturing the battery module 1 of the present embodiment includes determining a first reference position of the stacked body 12 based on a captured image. The method for manufacturing the battery module 1 of the present embodiment includes acquiring first position information representing a relative position of each part of the stacked body 12 with respect to the first reference position based on the image. The method for manufacturing the battery module 1 of the present embodiment includes storing the first reference position and the first position information. The method for manufacturing the battery module 1 of the present embodiment includes sharing the stored first reference position and first position information in subsequent steps.

Thus, in the method for manufacturing the battery module 1 of the present embodiment, since the stored first reference position and the first position information are shared by subsequent steps, it is possible to shorten the time for the positioning process as compared with an aspect in which positioning is performed every time each step is performed. As a result, in the method for manufacturing the battery module 1 of the present embodiment, the productivity of the battery module 1 can be improved.

Further, in the method for manufacturing the battery module 1 of the present embodiment, the subsequent steps include at least a wire bonding step S400 of coupling an electrode of the cell 30 and the predetermined bus bar 42 by the wire 44.

Thus, in the method for manufacturing the battery module 1 of the present embodiment, the coupling position of the wire 44 can be determined using the stored first reference position and the first position information, and as a result, the work efficiency of wire bonding can be improved.

### Modifications

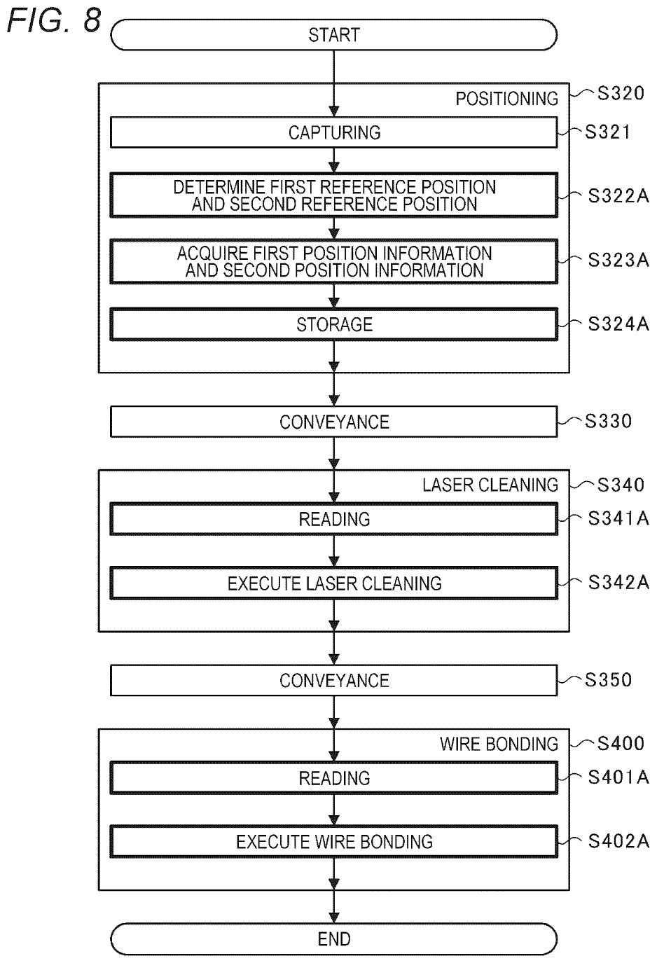

FIG. 8 is a flowchart for describing a detailed flow from the positioning step S320 to the wire bonding step S400 in the method for manufacturing the battery module 1 of the modification. In the above embodiment, just one reference position is determined. On the other hand, in the modification, two reference positions of a first reference position and a second reference position are determined. Hereinafter, points different from the above embodiment will be described, and description of substantially the same points as the above embodiment will be omitted for convenience.

As illustrated in FIG. 8, in the positioning step S320, after the semi-finished product is captured, the first reference position and the second reference position of the stacked body are determined based on the captured first image (S322A). The first reference position includes a first characteristic portion serving as a reference for determining the relative position of each part of the stacked body 12. The second reference position includes a second characteristic portion serving as a reference for determining the relative position of each part of the stacked body 12. The second characteristic portion is a characteristic portion located at a different position from the first characteristic portion, and may be a characteristic portion of the same type as the first characteristic portion. For example, a portion having a predetermined shape in the first bus bar 42 in the image may be set as the first reference position, and a portion having a predetermined shape in the second bus bar 42 in the image may be set as the second reference position. In addition, when the positioning pins 110 are formed in the bus bar module 14, the first positioning pin 110 may be set to the first reference position, and the second positioning pin 110 may be set to the second reference position.

Next, based on the captured first image, the first position information representing the relative position of each part of the stacked body 12 with respect to the first reference position is acquired, and second position information representing the relative position of each part of the stacked body 12 with respect to the second reference position is acquired (S323A). That is, the first position information represents the predetermined position as a relative position from the first reference position, and the second position information represents the predetermined position as a relative position from the second reference position. The first position information and the second position information may include information on the positions of the positive electrode and the negative electrode for each cell 30, or may include information on the position where the wire 44 is coupled to the bus bar 42.

Next, the captured first image, first reference position, second reference position, the first position information, and the second position information are stored in the storage 136 (S324A).

In the laser cleaning step S340, first, the first reference position, the second reference position, the first position information, and the second position information stored in the positioning step S320 are read (S341A).

Next, laser cleaning is executed according to the read first reference position, second reference position, first position information, and second position information (S342A).

For example, a characteristic portion substantially the same as the first reference position on the second image captured in the laser cleaning step S340 may be set as a first origin of the coordinate system of the laser cleaning. Similarly, a characteristic portion substantially the same as the second reference position on the second image may be a second origin of the coordinate system of the laser cleaning.

In the laser cleaning, the irradiation position of the laser may be determined according to the first position information and the second position information. For example, in the laser cleaning, a position in the second image represented by the first position information from the first origin in the second image and represented by the second position information from the second origin in the second image may be derived as the irradiation position of the laser. Alternatively, in the laser cleaning, for example, a position where a relative position with respect to the first origin in the second image and a relative position with respect to the second origin in the second image coincide with relative positions represented by the first position information and the second position information, respectively, may be derived as the irradiation position of the laser. That is, the laser cleaning may be executed so that the positional relationship among the first origin in the second image, the second origin in the second image, and the laser irradiation position coincides with the positional relationship among the first reference position, the second reference position, and the position of each part of the stacked body 12. Then, the derived irradiation position is irradiated with a laser beam.

In the wire bonding step S400, first, the first reference position, the second reference position, the first position information, and the second position information stored in positioning step S320 are read (S401A).

Next, wire bonding is performed in accordance with the read first reference position, second reference position, first position information, and second position information (S402A).

For example, a characteristic portion substantially the same as the first reference position on the third image captured in the wire bonding step S400 may be the first origin of the coordinate system of the wire bonding. Similarly, a characteristic portion substantially the same as the second reference position on the third image may be the second origin of the coordinate system of the wire bonding.

In the wire bonding, the coupling position of the wire 44 may be determined according to the first position information and the second position information. For example, in the wire bonding, a position in the third image represented by the first position information from the first origin in the third image and represented by the second position information from the second origin in the third image may be derived as the coupling position of the wire 44. Alternatively, in the wire bonding, for example, a position where a relative position with respect to the first origin in the third image and a relative position with respect to the second origin in the third image coincide with relative positions represented by the first position information and the second position information, respectively, may be derived as the coupling position of the wire 44. That is, the wire bonding may be executed so that the positional relationship among the first origin in the third image, the second origin in the third image, and the coupling position of the wire 44 coincides with the positional relationship among the first reference position, the second reference position, and the position of each part of the stacked body 12. Then, the wire 44 is coupled to the derived coupling position.

Note that, here, the first reference position, the second reference position, the first position information, and the second position information stored in the positioning step S320 are shared in the laser cleaning step S340 and the wire bonding step S400. However, the step of using the first reference position, the second reference position, the first position information, and the second position information is not limited to the laser cleaning step S340 and the wire bonding step S400. The first reference position, the second reference position, the first position information, and the second position information may be shared in various subsequent steps after the positioning step S320.

As described above, the method for manufacturing the battery module 1 of this modification includes determining the second reference position of the stacked body 12 in addition to the first reference position based on the image. The method for manufacturing the battery module 1 of this modification includes acquiring, based on the image, second position information representing the relative position of each part of the stacked body 12 with respect to the second reference position in addition to the first position information. The method for manufacturing the battery module 1 of this modification includes storing the second reference position and the second position information in addition to the first reference position and the first position information. The method for manufacturing the battery module 1 of this modification includes sharing the stored second reference position and second position information in subsequent steps in addition to the stored first reference position and first position information.

Thus, in the method for manufacturing the battery module 1 of this modification, since the stored first reference position, second reference position, first position information, and second position information are shared by subsequent steps, it is possible to shorten the time for the positioning process as compared with an aspect in which positioning is performed every time each step is performed. As a result, in the method for manufacturing the battery module 1 of the present embodiment, the productivity of the battery module 1 can be improved.

In addition, in the method of manufacturing the battery module 1 of this modification, the position of each part of the stacked body is derived by two pieces of information (first position information and second position information) based on two reference positions (first reference position and second reference position). Therefore, in the method for manufacturing the battery module 1 of this modification, for example, even if the posture of the semi-finished product at the time of the subsequent step is different from the posture of the semi-finished product at the time of the positioning step S320, the position of each part of the stacked body 12 can be appropriately derived. That is, in the method of manufacturing the battery module 1 of this modification, it is possible to suppress a decrease in positioning accuracy without performing positioning every time each step is performed.

Although the embodiment of the disclosure has been described above with reference to the accompanying drawings, it goes without saying that the disclosure is not limited to such an embodiment. It will be apparent to those skilled in the art that various changes or modifications can be conceived within the scope described in the claims, and it is understood that these naturally belong to the technical scope of the disclosure.

1. A method of manufacturing a battery module comprising a stacked body including stacked units each including a first cell group and a second cell group in which cells extending in a first direction are arranged in a second direction orthogonal to the first direction, and a temperature control plate disposed between the first cell group and the second cell group and extending in the second direction, the method comprising:
capturing the stacked body;
determining a first reference position of the stacked body based on a captured image;
acquiring first position information representing a relative position of each part of the stacked body with respect to the first reference position based on the image;
storing the first reference position and the first position information; and
sharing the stored first reference position and first position information in subsequent steps.

2. The method for manufacturing the battery module according to claim 1, wherein
the subsequent steps include at least a wire bonding step of coupling an electrode of each of the cells and a predetermined bus bar by a wire.

3. The method for manufacturing the battery module according to claim 1, further comprising:
determining a second reference position of the stacked body in addition to the first reference position based on the image; and
acquiring second position information representing a relative position of each part of the stacked body with respect to the second reference position in addition to the first position information based on the image;
storing the second reference position and the second position information in addition to the first reference position and the first position information; and
sharing the stored second reference position and second position information in the subsequent steps in addition to the stored first reference position and first position information.
